(19) United States
(12) Patent Application Publication
(10) Pub. No.: US 2022/0074024 A1
(43) Pub. Date: Mar. 10, 2022

(54) METAL STRUCTURES

(71) Applicant: ROYAL MELBOURNE INSTITUTE OF TECHNOLOGY, Melbourne, Victoria (AU)

(72) Inventors: Jackson Leigh SMITH, Box Hill South (AU); Ma QIAN, Glen Iris (AU); Tingting SONG, Brunswick East (AU); Daniel LIANG, Mount Waverley (AU)

(73) Assignee: ROYAL MELBOURNE INSTITUTE OF TECHNOLOGY, Melbourne, Victoria (AU)

(21) Appl. No.: 17/417,714

(22) PCT Filed: Dec. 19, 2019
(86) PCT No.: PCT/AU2019/051414

§ 371 Date: Jun. 23, 2021

(30) Foreign Application Priority Data
Dec. 24, 2018 (AU) 2018904940

(51) Int. Cl. C22C 3/00; C23F 1/18; C23F 1/30; C25F 3/02; C22C 9/05

(52) U.S. Cl. CPC C22C 3/00; C23F 1/18; C22C 9/05; C25F 3/02; C23F 1/30

(57) ABSTRACT

A method for producing a metal structure comprising a porous inter-dendritic matrix defining a network of dendritic channels, the method comprising the steps of: preparing an alloy melt comprising a metal element and at least one alloying element, cooling the alloy melt to a solid alloy, wherein the cooling promotes formation of a network of dendrites rich in the at least one alloying element within an inter-dendritic matrix rich in the metal, dealloying the solid alloy to remove alloying element from the dendrites and the inter-dendritic matrix to obtain the metal structure.

### FIELD OF THE INVENTION

The invention relates generally to a method for obtaining a metal structure, the metal structure, and an antimicrobial device comprising the metal structure. The metal structure can have a multimodal pore size distribution.

### BACKGROUND OF THE INVENTION

Considerable research effort has been directed over the years to developing structures made of porous metal for specific industrial needs. Existing procedures for the fabrication of porous metals include dealloying of solid solution alloys. In essence, dealloying refers to the selective leaching of one or more elements out of a solid solution alloy to produce a residual porous structure. The left-over structure is rich with the element that is less reactive to the leaching medium (i.e. nobler) and presents a three-dimensional network of voids left by the removed more active element(s) (i.e. less noble). Dealloying procedures have conventionally been used to fabricate porous metal structures characterized by a network of interconnected pores with tunable size at the nanometre scale.

In that context, metal structures with pores having a multimodal pore size distribution (i.e. a distribution that peaks at least at two values across multiple length scales) are considered particularly valuable for a variety of applications.

Conventional dealloying procedures have been adapted to fabricate metal structures with pores having multimodal size distribution. That has been typically achieved by way of multi-step procedures involving the initial introduction of sacrificial micron-size fillers/templates into a solid alloy, followed by conventional dealloying to remove both the sacrificial filler/template and the less noble element(s) of the alloy. The resulting metal structure possesses both nanometer-size pores and micron-size voids corresponding to the removed filler/template.

However, while those multi-step dealloying procedures offer some fabrication flexibility, the resulting metal structures suffer from inherently poor mechanical stability. Also, the porosity network of those structures is generally characterised by high tortuosity and low permeability, effectively restricting fluid flow through the structure. This effectively limits the practical applicability of those structures in fluid treatment applications (e.g. filtration) due to the significant flow back pressure they generate during use, which further exposes the structures' mechanical fragility. In addition, the multi-step nature of conventional filler/templates approaches makes them inherently complex and limits their applicability on a large scale.

There remains therefore an opportunity to address or ameliorate one or more disadvantages or limitations of conventional methods and products, or to at least provide a useful alternative.

### SUMMARY OF THE INVENTION

The present invention provides a method for producing a metal structure comprising a porous inter-dendritic matrix defining a network of dendritic channels, the method comprising the steps of (i) preparing an alloy melt comprising a metal element and at least one alloying element, (ii) cooling the alloy melt to a solid alloy, wherein the cooling promotes formation of a network of dendrites rich in the at least one alloying element within an inter-dendritic matrix rich in the metal, and (iii) dealloying the solid alloy to remove the at least one alloying element from (a) the dendrites and (b) the inter-dendritic matrix to obtain the metal structure.

By the specific geometrical nature and spatial arrangement of dendrites in the solid alloy, the corresponding spatial organisation of the resulting network of dendritic channels after dealloying ensures mechanical continuity of the porous inter-dendritic matrix. As a result, the metal structure can inherently benefit from superior mechanical stability and durability relative to porous metal structures obtained by conventional filler/template routes or by dealloying a homogeneous solid alloy (i.e. having no dendrites).

Also, the specific combination of steps in the method of the invention advantageously allows for the fabrication of metal structures with pores having a multimodal pore size distribution. By “multimodal” pores size distribution is meant a distribution of pore sizes that peaks at two or more distinct average pore size values, each of which may fall within a distinct length scale from the other(s). By the expression “length scale” is meant herein a particular length determined with the precision of one order of magnitude. Accordingly, a “bimodal” pore size distribution would be one that peaks at two average values, a “trimodal” pore size distribution would be one that peaks at three average values, etc.

Since the dendrites are rich in the alloying element and the dealloying step subsequently removes alloying element, the dendrites are effectively removed from the solid alloy upon dealloying, leaving behind empty dendritic channels. As a result, the dealloyed structure comprises at least one regime of porosity associated with the dendritic channels and one associated with the porosity induced by removal of alloying element from the inter-dendritic matrix, giving rise to pores having at least a bimodal pore size distribution.

Further, the unique geometry of the network of dendritic channels offers superior fluid permeability relative to conventional porous metal structures thanks to its high specific surface area and interconnectivity. By the specific nature of their formation mechanism, the dendrites form in a lattice-like configuration. Upon dealloying, the dendrites are removed leaving a highly directional network of dendritic channels characterised by reduced tortuosity, improved permeability, and/or enhanced mechanical stability relative to conventional porous metal structures. Those characteristics advantageously confer the structures of the present invention with superior capability for smooth mass transfer combined with high mechanical stability.

In addition, by relying on the spontaneous formation of dendrites during cooling of the alloy, the method of the invention offers a procedure for the fabrication of structures with intricate porosity that can be significantly streamlined relative to conventional techniques.

The invention also provides a metal structure obtained by the method described herein.

In other aspects, the invention provides a metal structure comprising a porous inter-dendritic matrix defining a network of dendritic channels.

In further aspects, the invention relates to an antimicrobial device comprising a metal structure of the kind described herein.

Further aspects and/or embodiments of the invention are outlined below.

### BRIEF DESCRIPTION OF THE DRAWINGS

Embodiments of the invention will be now described with reference to the following non-limiting drawings, in which:

FIG. 1 shows (a) precursor alloy solid disks obtained after cooling, (b) as-dealloyed disks, (c) image of a sample during the dealloying procedure, and (d) back-scattered electron micrograph of the solid alloy microstructure,

FIG. 2 shows surface secondary electron micrographs obtained with a scanning electron microscope (SEM) of a copper structure obtained after dealloying an arc-melted Cu—Mn alloy at (a) 200 μm, (b) 50 μm, (c)-(d) 10 μm scale,

FIG. 3 shows surface secondary electron micrographs obtained with a scanning electron microscope (SEM) of a copper structure obtained after dealloying an arc-melted Cu—Mn alloy at (a) 100 μm, (b) 20 μm, (c) 5 μm, and (d) 3 μm scale,

FIG. 4 shows surface secondary electron micrographs obtained with a scanning electron microscope (SEM) of a copper structure obtained after dealloying an arc-melted Cu—Mn alloy at (a) 1 μm and (b) 200 nm scale,

FIG. 5 shows surface secondary electron micrographs obtained with a scanning electron microscope (SEM) of a gold structure obtained after dealloying an arc-melted Au—Co alloy at (a) 40 μm, (b) 100 μm, (c) 30 μm, and (d) 20 μm scale,

FIG. 6 shows contact angle measurements performed on (a) a dense copper surface and (b) an embodiment porous copper structure,

FIG. 7 shows serial dilution and plating of Staphylococcus Aureus bacteria on Tryptic Soy Agar (TSA) plates after 2 minutes of incubation with exposure to (a) stainless steel, (b) dense copper and (c) an embodiment porous copper structure,

FIG. 8 shows data for quantitative colony counting, colony forming units (CFU) of plated Staphylococcus Aureus bacteria after 2, 20, 60, 240, and 1440 minutes of incubation with exposure to stainless steel, dense copper and an embodiment porous copper structure, and

FIG. 9 shows secondary electron micrographs of fixed Staphylococcus Aureus bacteria after a two minute exposure to (a) a stainless steel surface, (b) a dense copper surface, and (c)-(f) an embodiment porous copper structure.

### DETAILED DESCRIPTION OF THE INVENTION

The method of the invention comprises a step of preparing an alloy melt, the alloy melt comprising a metal element and at least one alloying element. When in isolation, the term “alloy” is used herein according to its broadest meaning of a material resulting from the blending of two or more elements at an atomic level, at least one of which is a metal element. Accordingly, the expression “alloy melt” will be understood as indicating an alloy in the molten state. For the purpose of the invention the alloy melt may be made according to any means and procedure known to the skilled person, provided it provides a molten alloy.

In a typical procedure, constituting elements of the alloy (herein also referred to as “alloy precursors”) may be melted individually and subsequently mixed to form the alloy melt. Alternatively, at least one of the alloy precursors is melted (typically the main element of the alloy) and the other element(s) added to it to completely dissolve in it. As a further alternative solid alloy precursors (for example in particulate, powder, or ingot form) are first combined and the combination heated to a temperature that is sufficiently high to melt the elements and blend the molten elements to generate the alloy melt. The alloy precursors are heated to a melting temperature sufficient to liquefy them in their entirety. Examples of suitable melting temperatures include 5° C., 25° C., 50° C., or more than 100° C. above the temperature at which the alloy precursors are entirely liquid.

The alloy melt may then be held at the melting temperature for sufficient time to ensure homogenisation of the alloy melt. Accordingly, the actual melt temperature and time at the melt state may be any temperature and time that ensure complete homogenisation of the alloy precursors. In some embodiments, the alloy melt is heated and held at a temperature of about 300° C.-2,000° C. for at least 10 minutes to allow for homogenisation.

In some embodiments, one or more of the alloy precursors are heated separately. For example, each alloy precursor may be liquefied or partially liquefied before they are mixed together to form the alloy melt. In yet more embodiments, one or more of the alloy precursors are heated to different temperatures before they are mixed.

The alloy precursors may be heated to provide the alloy melt according to any suitable procedure known to the skilled person. In some embodiments, the alloy melt is prepared by resistance melting, arc-melting, induction melting, or a combination thereof. In resistance melting, an electrical resistance is used as source of heat. In the case of arc-melting, heating is achieved by charging the material by means of an electric arc. In the case of induction heating, heating is performed by electromagnetic induction through heat generated in the object by eddy currents at high frequency.

The alloy melt comprises a metal element. By the expression “metal element” is meant an element selected from Group 1 through 16 metals of the IUPAC Periodic Table of the Elements, including actinides, and lanthanides. For example, the metal element may be selected from lithium, sodium, potassium, magnesium, calcium, titanium, zirconium, vanadium, chromium, molybdenum, tungsten, iron, cobalt, palladium, platinum, copper, silver, gold, zinc, cadmium, aluminium, tin, indium and lead. In some embodiments, the metal element is selected from copper, gold, silver, aluminium, platinum, palladium, nickel, lead and a combination thereof. For example, the metal element may be copper.

The alloy melt also comprises at least one alloying element. By the expression “alloying element” is meant the element that forms the alloy in addition to the metal element. The at least one alloying element may be any element that can be combined with the metal element to form the alloy melt. In that regard, the at least one alloying element may be selected from, for example, metal elements of the kind described herein. In some embodiments, the at least one alloying element is selected from manganese, zinc, cobalt, iron, nickel, aluminium, indium and a combination thereof. For example, the at least one alloying element may be manganese.

The choice of the metal element and the respective alloying element may be dictated by considerations as to the relative chemical activity of those elements during the dealloying procedure. In a general sense, in the context of the present invention the metal element and the at least one alloying element will have contrasting resistance to corrosion. Specifically, the metal element will be one that has higher resistance to corrosion (i.e. is more “noble”) relative to the alloying element. This will emphasise the selectivity of the subsequent dealloying procedure to maximise removal of alloying element relative to the metal element. For the purpose of the invention, the metal element and the at least one alloying element may be selected based on their relative differential electrochemical potential. For example, when determined on the basis of the electrochemical series measured against a standard hydrogen electrode, the metal element and the at least one alloying element may be selected such that the differential electrochemical potential of the at least one alloying element relative to the metal element is at least 0.2V.

Accordingly, in some embodiments the differential electrochemical potential of the at least one alloying element relative to the metal element is at least 0.45V, 0.5V, 0.75V, 1V, 1.5V, 2V, or 2.5V when calculated on the basis of their respective standard electrochemical potential. For avoidance of doubt, assuming by way of example that copper (standard electrochemical potential of about +0.34V) is selected as the metal element, a suitable candidate for the at least one alloying element may be selected from elements having standard electrochemical potential of −0.26V or higher (e.g. −0.5V, −1V, −2V, −3V, etc.). This will ensure preferential removal of the at least one alloying element relative to copper during the dealloying step.

Examples of combinations of metal element and one or more alloying element that would be suitable for the purpose of the invention include copper-manganese, gold-cobalt, gold-iron, gold-nickel, aluminium-zinc, copper-zinc, silver-aluminium, platinum-iron, platinum-aluminium, palladium-manganese, palladium-cobalt, lead-indium or nickel-manganese.

One or more other factors may need to be taken into account when selecting suitable combinations of metal element and alloying element for the purpose of the invention. For example, the at least one alloying element may not be one having a boiling temperature that is lower than the melting temperature of the metal element (and vice versa). Also, one may not select elements that are chemically reactive when combined, especially at high temperature. In that regard, a skilled person will be aware of such additional considerations when selecting suitable combinations of metal element and alloying element.

The method of the invention comprises a step of cooling the alloy melt to a solid alloy. In particular, the cooling promotes formation of a network of dendrites rich in the at least one alloying element within an inter-dendritic matrix rich in the metal. As used herein, the term “dendrites” (and corresponding derivatives such as “dendritic”, etc.) indicates columnar crystals having a fractal tree-like geometrical shape having at least primary and secondary arms. Dendrites appear long and thin, with fractal arms growing along favorable crystallographic directions as a result of undercooling of the alloy.

The conditions leading to formation of a network of dendrites within the volume of a cooling alloy melt are determined by a number of factors, of which some determinant ones include the composition of the alloy melt and the rate at which it is cooled.

Typically, and without wanting to be confined by theory, dendrites form in a cooling alloy under constitutional undercooling conditions. So called “constitutional undercooling” arises in an alloy due to a negative concentration gradient ahead of the growth interface (i.e. ahead of the solid-liquid interface), in which the interface is at higher solute concentration and has a lower melting point than the melt far from the interface. Accordingly, growth of the solid phase can be unstable leading to dendrite growth if the melting point gradient change is higher than the thermal undercooling.

For a specific alloy melt composition, a skilled person would be capable of determining appropriate cooling conditions to ensure formation of a network of dendrites taking constitutional undercooling effects into consideration. It is however acknowledged that doing so may be counterintuitive, since conventional alloy fabrication procedures are designed to avoid formation of dendrites during cooling in order to maximise compositional homogeneity of the solid alloy. That is, conventional cooling procedures of alloys are performed to provide a homogeneous, single solid solution phase microstructure as opposed to a discontinuous and inhomogeneous dendritic phase. To that effect, conventional procedures involve extremely rapid cooling of the alloy melt (e.g. in excess of 1,000° C./s). Under such rapid cooling, the alloy melt microstructure freezes into a super-saturate homogeneous solid solution. In contrast, the cooling step of the present invention is purposely designed to induce formation of a network of dendrites.

Accordingly, in the method of the invention the alloy melt may be cooled at any cooling rate that ensures formation of dendrites. In some embodiments, the cooling of the alloy melt is performed at a cooling rate of less than about 10,000° C./s. For example, the cooling of the alloy melt may be performed at a cooling rate of less than about 5,000° C., less than about 1,000° C., less than about 750° C., less than about 500° C., less than about 250° C./s, less than about 100° C./s, less than about 50° C./s, less than about 10° C./s, or less than about 1° C./s. In some embodiments, the cooling of the alloy melt is performed at a cooling rate of between about 0.01° C./s and 1° C./s, or between about 0.01° C./s and 0.5° C./s.

In the method of the invention the alloy melt may be cooled in accordance with any procedure that ensures formation of dendrites. For example, the cooling of the alloy melt may be performed by casting (e.g. drop-casting, suction casting, etc.), drum spinning, centrifugal spinning, or solution quenching, under cooling rate that ensures formation of dendrites. Any combination of melting and cooling procedures resulting in formation of a network of dendrite within the solid alloy would be suitable for the purpose of the invention.

Any composition of the alloy providing for formation of a network of dendrites within the solid alloy upon cooling would be suitable in the context of the present invention. In that regard, the chemical composition of the alloy melt can play a role in determining the structure of the dendrites that form during cooling of the alloy melt. For example, for a given set of cooling parameters (e.g. cooling rate) the amount of alloying element may be inversely proportional to the width of the dendrites. As a result, higher amounts of the at least one alloying element can lead to formation of higher number of narrower dendrites relative to lower amounts of the at least one alloying element.

In some embodiments, the alloy melt has an atomic content of the metal element of between about 20% and about 60%, between about 30% and about 60%, between about 40% and about 60%, or between about 50% and about 60%. In some embodiments, the alloy melt has an atomic content of the at least one alloying element of between about 40% and about 80%, between about 40% and about 70%, between about 40% and about 60%, or between about 40% and about 50%.

In the method of the invention the cooling results in the formation of dendrites rich in the at least one alloying element within an inter-dendritic matrix rich in the metal. With reference to a particular element, by a certain phase of the solid alloy being “rich” in that element means that the atomic content of that element in that phase is at least 50%. Depending on the chemical composition of the alloy melt, the cooling results in a network of dendrites having a variety of compositions.

In some embodiments, the cooling promotes formation of a network of dendrites having an atomic content of the at least one alloying element of between about 60% and about 100%. For example, the cooling may promote formation of a network of dendrites having an atomic content of the at least one alloying element of between about 60% and about 99%, between about 60% and about 90%, between about 60% and about 75%, between about 65% and about 75%, or between about 70% and about 75%.

Formation of a network of dendrites during cooling of the alloy melt corresponds to the formation of an inter-dendritic matrix. For avoidance of doubt, the expression “inter-dendritic matrix” refers herein to the phase of the solid alloy surrounding the network of dendrites. The inter-dendritic matrix that forms upon cooling is rich in the metal element. In some embodiments, the cooling promotes formation of an inter-dendritic matrix having an atomic content of the metal element of between about 50% and about 60%. For example, the cooling may promote formation of an inter-dendritic matrix having an atomic content of the metal element of between about 55% and about 60%.

The respective structure and composition of the dendrites and the inter-dendritic matrix are relevant factors in determining the mechanical properties of the solid alloy, and eventually of the metal structure after the dealloying step. In that regard, it is favourable to promote formation of an inter-dendritic phase that combines high metal element content, high ductility, and toughness. This can subsequently ensure good mechanical integrity of the dealloyed metal structure. For a given alloy melt composition, a skilled person would be able to predict the desired composition, microstructure, and corresponding mechanical characteristics of the inter-dendritic matrix on the basis of, for example, the phase diagram of the specific combination of elements. Accordingly, the composition of the alloy melt may be tailored based on the desired composition of the inter-dendritic matrix.

In some embodiments, the cooling of the alloy melt promotes formation of an inter-dendritic matrix having a face-centred-cubic (fcc) crystal structure. As a result, the inter-dendritic matrix and the resulting dealloyed metal structure are characterised by high ductility and can display advantageous mechanical stability.

The physical ductility of the inter-dendritic phase can also be a good indicator of the mechanical stability of the dealloyed metal structure. In that regard it is advantageous to ensure that the solid alloy has an inter-dendritic phase with sufficient physical ductility to provide the metal structure with mechanical strength.

The hardness of the inter-dendritic matrix may also provide an indirect indication of the mechanical characteristics of the dealloyed structure. In that regard, it may be advantageous to cool the alloy melt to promote formation of an inter-dendritic matrix having Vickers Hardness (HV 300 gf/10 s) of between about 50 and about 200. In some embodiments, the cooling of the alloy melt promotes formation of an inter-dendritic matrix having Vickers Hardness (HV 300 gf/10 s) of between about 50 and about 500, between about 75 and about 400 between about 100 and about 300, or between about 100 and about 200.

Advantageous combinations of ductility and hardness of the inter-dendritic matrix may be achieved with alloy melts having an atomic content of the metal element of between about 25% and 45%, the remainder being the one or more alloying element and impurities, if present. Accordingly, in some embodiments the alloy melt has an atomic content of the metal element of between about 25% and about 45%, between about 30% and about 45%, or between about 35% and about 40%, the remainder being the one or more alloying element and impurities, if present. In that context, it is advantageous to cool the alloy melt to promote formation of an inter-dendritic matrix having an atomic content of the metal alloy of between about 50% and about 70%.

Examples of metal elements that can be used to obtain alloy melts which, once cooled, result in formation of an inter-dendritic matrix having good mechanical properties include copper, iron, gold, silver, tin, lead, platinum, palladium, and nickel. A specific example of an alloy composition that can achieve an advantageous combination of ductility and hardness of the inter-dendritic matrix is Cu—Mn alloy, in particular Cu—Mn alloy having an atomic content of Cu between about 25% and about 45%. Accordingly, in some embodiments the alloy melt comprises Cu and Mn with an atomic content of Cu of between about 25% and about 45%, the remainder being Mn and impurities, if present. For example, the alloy melt may comprise Cu and Mn with an atomic content of Cu of about 25%, about 30%, about 35%, about 40%, or about 45%, the reminder being Mn and impurities, if present. Those concentrations can lead to a favourable composition of the inter-dendritic matrix following cooling. Accordingly, in some embodiments the alloy melt comprises Cu and Mn with an atomic content of Cu of between about 25% and about 45%, the remainder being Mn and impurities, if present, and the cooling of the alloy melt promotes formation of an inter-dendritic matrix having an atomic content of Cu of about 50%, about 55%, or about 60%.

In the method of the invention the cooling promotes formation of a network of dendrites. The shape and size of the dendrites can also play a relevant role in the determination of the mechanical characteristics of the metal structure following dealloying. For example, it is beneficial to promote formation of a network of elongated branched dendrites having multiple branching levels. The spacing of the dendrites within the network of dendrites may also be controlled to ensure the inter-dendritic matrix has sufficient volumetric development and interconnectivity to be self-supporting once the network of dendrites is removed during the dealloying procedure. In some embodiments, the cooling of the alloy melt promotes formation of a network of dendrites comprising dendrites having primary arms with an average length of at least about 50 μm, at least about 100 μm, at least about 200 μm, at least about 400 μm, or at least about 800 μm. In some embodiments, the dendrites comprise secondary arms having an average length of at least about 5 μm, at least about 10 μm, at least about 25 μm, at least about 50 μm, at least about 100 μm, at least about 200 μm, or at least about 400 μm. In some embodiments, the dendrites also comprise tertiary arms having a length of at least about 5 μm, at least about 10 μm, at least about 25 μm, at least about 50 μm, at least about 100 μm, at least about 200 μm, or at least about 400 μm.

It may be advantageous to cool the alloy melt to promote formation of a network of dendrites in which dendrites are sufficiently spaced apart to ensure material continuity of the inter-dendritic network. Accordingly, in some embodiments the cooling of the alloy melt promotes formation of a network of dendrites comprising dendrites having an average dendritic arm spacing (primary arm) in the range of about 1 μm to about 100 μm, about 1 μm to about 50 μm, about 1 μm to about 25 μm, about 1 μm to about 10 μm, or about 1 μm to about 5 μm. A skilled person would be capable to adapt cooling conditions and procedures of the kind described herein to achieve the desired shape and size of dendrites in the network of dendrites.

The present invention also comprises a step of dealloying the solid alloy. The function of the dealloying step is that of selectively removing the at least one alloying element from the solid alloy. This can be achieved by the at least one alloying element being less resistant to corrosion relative to the metal element, as explained herein.

The dealloying step of the invention may be performed in accordance to any procedure known to the skilled person that results in (i) the preferential removal of alloying element over the metal element and (ii) the redistribution of the metal element (nobler) within the inter-dendritic matrix by surface diffusion. Examples of dealloying procedures that may be suitable for the purpose of the invention include chemical dealloying, and electrochemical (or potentiostatic) dealloying.

In some embodiments, the dealloying step comprises a chemical dealloying procedure. In such procedure the solid alloy is immersed into a dealloying solution which is corrosive to the less noble elements in the solid alloy. Factors such as the chemical composition of the dealloying solution, the dealloying temperature, and dealloying time can affect the diffusivity of the less noble elements and therefore the resulting metal structure.

Examples of dealloying solutions for use in the invention include aqueous solutions of an acid or a base. The acid or the base may be any acid or base that ensures effective and selective removal of the at least one alloying element from the solid alloy.

In some embodiments, the dealloying solution is an aqueous solution of an acid selected from hydrochloric acid (HCl), nitric acid (HNO₃), sulfuric acid (H₂SO₄), hydrobromic acid (HBr), hydroiodic acid (HI), perchloric acid (HClO₄), chloric acid (HClO₃), hydrofluoric acid (HF), and a combination thereof. The concentration of the acid may be any concentration that ensures effective and selective removal of the at least one alloying element from the solid alloy. For example, the acid in the dealloying solution is present in a concentration of at least 0.1M, at least 1M, at least 5M, at least 10M, or at least 50M.

In some embodiments, the dealloying solution is an aqueous solution of a base selected from lithium hydroxide (LiOH), sodium hydroxide (NaOH), potassium hydroxide (KOH), rubidium hydroxide (RbOH), cesium hydroxide (CsOH), calcium hydroxide (Ca(OH)₂), strontium hydroxide (Sr(OH)₂), barium hydroxide (Ba(OH)₂), or a combination thereof. The concentration of the acid may be any concentration that ensures effective and selective removal of the at least one alloying element from the solid alloy. For example, the base in the dealloying solution is present in a concentration of at least 0.1M, at least 1M, at least 5M, at least 10M, or at least 50M.

In some embodiments, the dealloying step comprises electrochemical dealloying. Such dealloying, also referred to as potentiostatic dealloying, is based on the use of the solid alloy as an electrode in an electrochemical cell containing an electrolyte solution, a working electrode and a counter electrode. The solid alloy effectively functions as a sacrificial electrode in which the at least one alloying element is dissolved into the electrolyte solution during operation. The electrolyte for use in electrochemical dealloying may be any electrolyte that assists with the selective removal of the at least one alloying element. In some embodiment, the electrolyte is an aqueous solution of NaCl, or KCl. In other embodiments, the electrolyte is an aqueous solution of an acid or a base of the kind described herein.

The dealloying procedure may be performed at any dealloying temperature that ensures effective and selective removal of alloying element from the solid alloy. In some embodiments, the dealloying is performed at a dealloying temperature between about 20° C. and about 300° C., between about 20° C. and about 150° C., between about 20° C. and about 100° C., between about 40° C. and about 100° C., or between about 75° C. and about 100° C. When the dealloying involves the use of an aqueous solution the dealloying temperature may be below the boiling temperature of the solution. Accordingly, in some embodiments the dealloying temperature is between about 20° C. and about 100° C., between about 30° C. and about 100° C., between about 40° C. and about 100° C., between about 50° C. and about 100° C., between about 60° C. and about 100° C., between about 70° C. and about 100° C., between about 80° C. and about 100° C., or between about 90° C. and about 100° C.

The dealloying procedure may be performed for a time sufficient to ensure effective and selective removal of the at least one alloying element from the solid alloy. In some embodiments, the dealloying procedure is performed for between about 1 minute and about 48 hours, between about 1 minute and about 24 hours, between about 1 minute and about 12 hours, between about 1 minute and about 6 hours, between about 1 minute and about 2 hours, between about 1 minute and about 1 hour, between about 1 minute and about 45 minutes, between about 1 minute and about 30 minutes, or between about 1 minute and about 15 minutes.

The dealloying step results in effective removal of alloying element from the dendrites and the inter-dendritic matrix to obtain the metal structure. By “effective removal” is meant that at least 90%, for example at least 95% or at least 99%, of the at least one alloying element is removed from the solid alloy. Since the dendrites are rich in alloying element, by removing alloying element form the dendrites the dealloying procedure of the invention effectively results in the dissolution of the dendrites. This leaves a network of void channels within the inter-dendritic matrix which geometry repeats that of the dendrites, herein referred to as “network of dendritic channels”. Conversely, removal of alloying element from the metal element-rich inter-dendritic matrix results in a porous inter-dendritic matrix made of the metal element surrounding the network of dendritic channels. The porous nature of the dealloyed inter-dendritic matrix is the result of the combined removal of the alloying element and the atomic redistribution of metal elements.

Following dealloying, the metal structure comprises a network of dendritic channels. The size and shape of the channels substantially repeat that of the dendrites. In some embodiments, the dendritic channels have a main axial length of at least about 50 μm, at least about 100 μm, at least about 200 μm, at least about 400 μm, or at least about 800 μm. In some embodiments, the dendritic channels comprise secondary channels corresponding to the secondary branches of the dendrites and having a length of at least about 5 μm, at least about 10 μm, at least about 25 μm, at least about 50 μm, at least about 100 μm, at least about 200 μm, or at least about 400 μm. In some embodiments, the dendritic channels also comprise tertiary channels corresponding to the tertiary branches having a length of at least about 5 μm, at least about 10 μm, at least about 25 μm, at least about 50 μm, at least about 100 μm, at least about 200 μm, or at least about 400 μm.

Also, the average cross-sectional size and geometry of the dendritic channels substantially repeat those of the dendrites. That is, the network of dendritic channels presents at least primary channels corresponding to the stems of the dendrites and secondary channels stemming from the primary channels and corresponding to the secondary dendritic arms. In some embodiments, the average cross-sectional size of the primary channels is at least about 0.5 μm, at least about 1 μm, at least about 2.5 μm, at least about 5 μm, at least about 10 μm, at least about 25 μm, at least about 100 μm, or at least about 250 μm. In some embodiments, the average cross-sectional size of the secondary channels is at least about 0.5 μm, at least about 1 μm, at least about 2.5 μm, at least about 5 μm, at least about 10 μm, at least about 25 μm, at least about 100 μm, or at least about 250 μm. The network of dendritic channels may further comprise tertiary channels corresponding to tertiary arms of the dendrites, when present. In some embodiments the network of dendritic channels further comprises tertiary channels having average cross-sectional size of at least about 0.5 μm, at least about 1 μm, at least about 2.5 μm, at least about 5 μm, at least about 10 μm, at least about 25 μm, at least about 100 μm, or at least about 250 μm.

Following dealloying, the metal structure also comprises a porous inter-dendritic matrix. By the inter-dendritic matrix being “porous” is meant that the inter-dendritic matrix presents a network of interconnected pores (i.e. voids). Without wanting to be limited by theory, it is believed the pores form during the dealloying step as a result of the combined removal of alloying element and redistribution of the metal element by surface diffusion. The pores of the inter-dendritic phase may be characterised by average size of less than 1,000 nm. As used herein, by “average size” of the pores of the inter-dendritic matrix is meant the average size of the pores as determined by standard porosimetry procedures, and specifically gas adsorption and mercury porosimetry (as appropriate depending on the size ranges of the sampled pores).

Accordingly, in some embodiments the porous inter-dendritic matrix comprises pores having an average size of less than about 1,000 nm, less than about 500 nm, less than about 250 nm, less than about 100 nm, less than about 75 nm, less than about 50 nm, less than about 25 nm, less than about 10 nm, less than about 5 nm, or less than about 2.5. For example, the porous inter-dendritic matrix may comprise pores having an average size of between about 1 nm and about 1,000 nm, of between about 1 nm and about 500 nm, of between about 5 nm and about 250 nm, of between about 10 nm and about 100 nm, or of between about 20 nm and about 50 nm. In some embodiments, the porous inter-dendritic matrix comprises pores having an average size of between about 20 nm and about 1,000 nm.

The inter-dendritic matrix may be microporous. By being “microporous” is meant that the inter-dendritic matrix has pores with an average size of less than 2 nm (micropores), in accordance with International Union of Pure and Applied Chemistry (IUPAC) nomenclature.

The inter-dendritic matrix may be mesoporous. By being “mesoporous” is meant that the inter-dendritic matrix has pores with an average size in the range of 2-50 nm (mesopores), in accordance with International Union of Pure and Applied Chemistry (IUPAC) nomenclature.

The inter-dendritic matrix may be macroporous. By being “macroporous” is meant that the inter-dendritic matrix has pores with an average size larger than 50 nm (macropores), in accordance with International Union of Pure and Applied Chemistry (IUPAC) nomenclature.

The metal structure obtained by the method of the invention is therefore characterised by multiple regimes of porosity sizes deriving at least from the average size of the dendritic channels and the average size of the pores in the inter-dendritic matrix. In other words, the metal structure obtained by the method of the invention comprises voids which size distribution is at least bimodal (i.e. peaks at least at two average values), with each average value peaking within a discrete length scale relative to the other(s). This advantageously confers to the metal structure superior capability for smooth mass transfer relative to porous metal structures obtained by conventional procedures.

For example, the metal structure may comprise an inter-dendritic matrix having pores of average size of less than about 500 nm, for instance less than 100 nm or less than 50 nm, and a network of dendritic channels with an average cross-sectional size of the primary channels of at least about 1 μm, for instance at least about 5 μm or about 10 μm. Accordingly, in some embodiments the metal structure comprises an inter-dendritic matrix having pores of average size of less than 100 nm and a network of dendritic channels with an average cross-sectional size of the primary channels of at least about 1 μm.

The present invention also provides a metal structure comprising a porous inter-dendritic matrix defining a network of dendritic channels.

The metal structure of the invention may be made of a metal element of the kind described herein. By the structure being “made” of a certain metal element is meant that the metal element is present in the structure at an atomic content of at least 85%.

In some embodiments, the metal structure is made of a metal element selected from Group 1 through 16 metals of the IUPAC Periodic Table of the Elements, including actinides, and lanthanides. For example, the metal element may be selected from lithium, sodium, potassium, magnesium, calcium, titanium, zirconium, vanadium, chromium, molybdenum, tungsten, iron, cobalt, palladium, platinum, copper, silver, gold, zinc, cadmium, aluminium, tin, and lead. In some embodiments, the metal element is selected from copper, gold, silver, aluminium, platinum, palladium, nickel, and a combination thereof. For example, the metal structure may be made of copper.

The porous inter-dendritic matrix and the network of dendritic channels in the metal structure of the invention may be of the kind described herein. The metal structure is therefore characterised by multiple regimes of porosity sizes deriving at least from the average size of the dendritic channels and the average size of the pores in the inter-dendritic matrix.

The network of dendritic channels presents at least primary channels corresponding to dendrite stems and secondary channels stemming from the primary channels. The channels may be characterised by any fractal geometry and size that is allowed without compromising the mechanical integrity of the metal structure.

In some embodiments, the average cross-sectional size of the primary channels is at least about 0.5 μm, at least about 1 μm, at least about 2.5 μm, at least about 5 μm, at least about 10 μm, at least about 25 μm, at least about 100 μm, or at least about 250 μm. In some embodiments, the average cross-sectional size of the secondary channels is at least about 0.5 μm, at least about 1 μm, at least about 2.5 μm, at least about 5 μm, at least about 10 μm, at least about 25 μm, at least about 100 μm, or at least about 250 μm. The network of dendritic channels may further comprise tertiary channels stemming from the secondary channels. Accordingly, in some embodiments the network of dendritic channels further comprises tertiary channels having average cross-sectional size of at least about 0.5 μm, at least about 1 μm, at least about 2.5 μm, at least about 5 μm, at least about 10 μm, at least about 25 μm, at least about 100 μm, or at least about 250 μm.

In addition, the dendritic channels may have a main axial length of at least about 50 μm, at least about 100 μm, at least about 200 μm, at least about 400 μm, or at least about 800 μm. In some embodiments, the dendritic channels also comprise secondary channels having a length of at least about 5 μm, at least about 10 μm, at least about 25 μm, at least about 50 μm, at least about 100 μm, at least about 200 μm, or at least about 400 μm. In some embodiments, the dendritic channels also comprise tertiary channels stemming from the second channels and having a length of at least about 5 μm, at least about 10 μm, at least about 25 μm, at least about 50 μm, at least about 100 μm, at least about 200 μm, or at least about 400 μm.

The inter-dendritic matrix may have any porosity characteristics to the extent that the mechanical integrity of the metal structure is not compromised. In some embodiments the porous inter-dendritic matrix comprises pores having an average size of less than about 1,000 nm, less than about 500 nm, less than about 250 nm, less than about 100 nm, less than about 75 nm, less than about 50 nm, less than about 25 nm, less than about 10 nm, less than about 5 nm, or less than about 2.5. For example, the porous inter-dendritic matrix may comprise pores having an average size of between about 20 nm and about 1,000 nm, of between about 20 nm and about 500 nm, of between about 20 nm and about 250 nm, of between about 20 nm and about 100 nm, or of between about 20 nm and about 50 nm.

The inter-dendritic matrix may be one of microporous, mesoporous, or macroporous, according to the definitions given herein. In some embodiments, the inter-dendritic matrix is microporous. In some embodiments, the inter-dendritic matrix is mesoporous. In some embodiments, the inter-dendritic matrix is macroporous. In some embodiments, the inter-dendritic matrix may be a combination two or more of microporous, mesoporous, or macroporous.

The metal structure of the invention is therefore characterised by multiple regimes of porosity sizes deriving at least from the average size of the dendritic channels and the average size of the pores in the inter-dendritic matrix. In other words, the metal structure of the invention comprises voids which size distribution is at least bimodal (i.e. peaks at least at two values), with each average value peaking within a discrete length scale relative to the other(s). This advantageously confers to the metal structure superior capability for smooth mass transfer relative to porous metal structures obtained by conventional procedures.

For example, the metal structure may comprise an inter-dendritic matrix having pores of average size of less than about 500 nm, for instance less than 100 nm or less than 50 nm, and a network of dendritic channels with an average cross-sectional size of the primary channels of at least about 1 μm, for instance at least about 5 μm or about 10 μm. Accordingly, in some embodiments the metal structure may comprise an inter-dendritic matrix having pores of average size of less than 100 nm and a network of dendritic channels with an average cross-sectional size of the primary channels of at least about 1 μm.

The metal structure of the invention is characterised by mechanical integrity, in that the structure is self-supporting and displays structural rigidity under an external force. To that effect, the metal structure of the invention may present any microstructure that guarantees mechanical integrity. In some embodiments, the inter-dendritic matrix has a face-centred-cubic (fcc) crystal structure. As a result, the metal structure is characterised by high ductility and displays advantageous mechanical stability. The physical ductility of the inter-dendritic phase can also be a good indicator of the mechanical stability of the dealloyed metal structure. In that regard it is advantageous to ensure that the solid alloy has an inter-dendritic phase with sufficient physical ductility to provide the metal structure with mechanical strength.

The hardness of the inter-dendritic matrix may also contribute to the mechanical integrity of the metal structure. In that regard, it is advantageous if the inter-dendritic matrix has Vickers Hardness (HV 300 gf/10 s) of between about 50 and about 500. In some embodiments, the metal structure comprises an inter-dendritic matrix having Vickers Hardness (HV 300 gf/10 s) of between about 50 and about 500, between about 75 and about 400 between about 100 and about 300, or between about 100 and about 200.

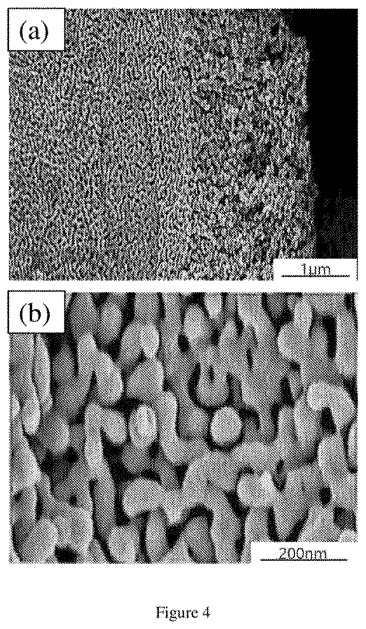

The combination of the network of dendritic channels and superficial nanosized features of the metal structures of the present invention provide advantageous surface wettability characteristics. In particular, the inter-dendritic matrix may present a surface morphology that is characterised by interconnected nano-sized metal ligaments defining a network of interconnected micropores or mesopores. Such morphology is observed to form, for example, during dealloying procedures of the kind described herein. FIG. 4(b) shows an example of such surface morphology. When seen from a side direction (not shown), the nanosized metal ligaments are shaped as columnar nano-sized protrusions extending towards the exterior of the structure.

The average distance between adjacent nanosized metal ligaments may be in the range of units of nanometres to hundreds of nanometres. For example, the average distance between adjacent nanosized metal ligaments may be between about 1 nm and about 200 nm, between about 1 nm and about 100 nm, between about 1 nm and about 50 nm, between about 1 nm and about 50 nm, or between about 1 nm and about 50 nm. Such structural superficial features in combination with the network of dendritic channels advantageously provide strong capillary effects towards polar liquids, such as water. Those capillary effects add to the intrinsic hydrophilicity of the metal forming the structure resulting in the structure being highly hydrophilic, and in some case super-hydrophilic. By the structure being “hydrophilic” is meant that a water droplet would rest on a flat surface of the structure with a static contact angle of less than 60°. When the static contact angle is below 10°, the structure is considered to be “super-hydrophilic”. For a given surface, the “static contact angle” is the angle between the water-surface interface and the tangent line of the curve at the contact point of the water and the surface. In the context of the invention the static contact angle is the sessile drop contact angle measured by a contact angle goniometer using an optical subsystem to capture the profile of a water droplet on a flat surface of the metal structure.

Accordingly, in some embodiments the metal structure of the invention provides for a static contact angle with water of less than 60°, less than 45°, less than 50°, less than 25°, less than 10°, less than 50°, or less than 1°. In some embodiments the static contact angle is about 0°.

When super-hydrophilic, the metal structures of the invention ensure that water lies substantially flat on their surface. The ability of getting water to lie flat on a surface (i.e. as a flat film) as opposed to in the form of droplets is one of the crucial surface properties which play an important role in many practical applications.

In that regard, bacterial attachment and growth on material surfaces are considered to be the primary steps leading to the formation of infectious biofilms. Such biofilms in hospital and food processing settings can result in bacterial infection and food contamination, respectively. Prevention of bacterial attachment, therefore, is considered to be the best strategy for abating these pathogens and therefore the development of antibacterial metal structures becomes important. Advantageously, the metal structures of the invention can display significant antimicrobial activity.

By “antimicrobial” properties is meant the ability to kill and/or inhibit growth of pathogens, which include infectious microorganisms such as a virus, bacterium, protozoa, prion, and fungus. In this context, and without wanting to be limited by theory, pathogens that come into contact with hydrophilic or super-hydrophilic metal structures of the kind described herein are subjected to intense mechanical strain deriving from the capillary interactions between the hydrophilic components of their cellular membrane and the morphological features of the metal structure. This has been observed to effectively promote mechanical cell lysis induced by adhesion-strain.

The antimicrobial properties of the structures of the invention can be further emphasised when the metal structures are made of a metal with intrinsic antimicrobial properties. Examples of such metals include cobalt, nickel, copper, zinc, zirconium, molybdenum, and lead. The antimicrobial nature of those metals derives from the inherent toxicity of their ions to pathogen cells. Advantageously, hydrophilic and super-hydrophilic structures made of any of those metals offer superior antimicrobial characteristics thanks to a combination of morphological and chemical antimicrobial functionality. In particular, the elevated surface area associated with the surface morphology of those metal structures induces both physical strain of the pathogen cells and enhanced intake of toxic ions within the cells.

Accordingly, the present invention also provides an antimicrobial device comprising a metal structure of the kind described herein. For example, the antimicrobial device comprises a metal structure of the kind described herein that is made of a metal selected from cobalt, nickel, copper, zinc, zirconium, molybdenum, lead, and a combination thereof. For example, the antimicrobial device comprises a metal structure of the kind described herein that is made of copper. In some embodiments, the antimicrobial device is selected from a filter, a humidifier wick, a touch surface, and a container.

### EXAMPLES

### Example 1

The alloy melt was prepared by assembling the raw materials in a water-cooled crucible. The crucible was evacuated and partially backfilled with inert gas prior to being heated under reduced pressure until the materials were molten.

Suction-cast arc-melted precursor alloy rods were sectioned into small circular disks for repeatable data. Two alloy systems containing different noble metals (Cu₃₀Mn₇₀ and Au₃₀Co₇₀) were used as precursors. Nanoporous Cu disks of equal geometry were produced by free corrosion in 1M HCl, while nanoporous Au samples were produced by free corrosion in 10M HNO₃.

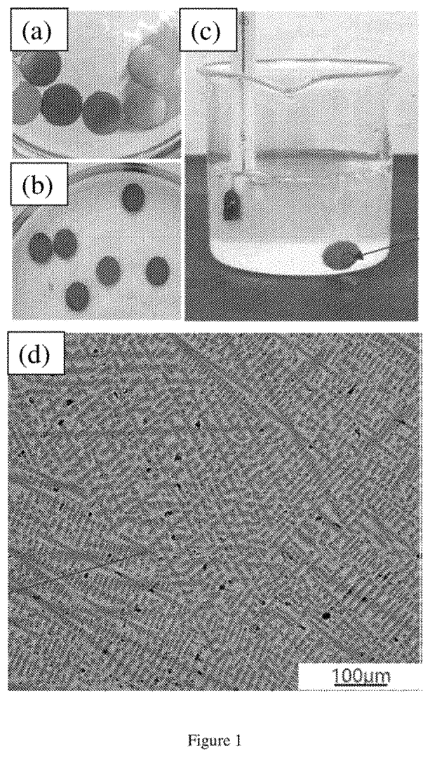

FIGS. 1(a)-(c) show pictures of different steps of an embodiment method of the invention. FIG. 1(a) shows precursor alloy disks obtained by sectioning solidified alloy rods. FIG. 1(b) shows as-dealloyed porous copper disks. FIG. 1(c) shows an image of one of the samples immersed in the dealloying solution. The image refers to the chemical dealloying process to selectively remove Mn from a precursor alloy disk having Cu₃₀Mn₇₀ composition, using a 1M aqueous solution of HCl at 60° C. for approximately 30 minutes. FIG. 1(d) shows a back-scattered electron micrograph of the as-solidified alloy microstructure. The composition of the microstructure was determined analytically and consisted of γ phase Mn-rich dendrites (darker lines) within a Cu-rich inter-dendritic matrix.

SEM backscattered electrons (BSE) micrographs of the as-cast microstructure clearly display a dendritic/inter-dendritic microstructure with chemically contrasting phases. Energy-dispersive X-ray spectroscopy (EDS) analysis of the dendritic phase reveals a significant difference in chemical composition, with Mn rich dendrites (82.6 at % Mn) in the Cu—Mn alloy while the Au—Co alloy consisted of Co rich dendrites (2 at %. Co).

The inter-dendritic phases were Cu rich (49.9 at % Mn) and Au rich (60 at % Au). The observed microstructure was formed due to the chemical segregation as a result of limited diffusion under the given solidification conditions, forming primarily less noble rich dendrites with a significant amount of more noble metal atoms supersaturated in the inter-dendritic phase.

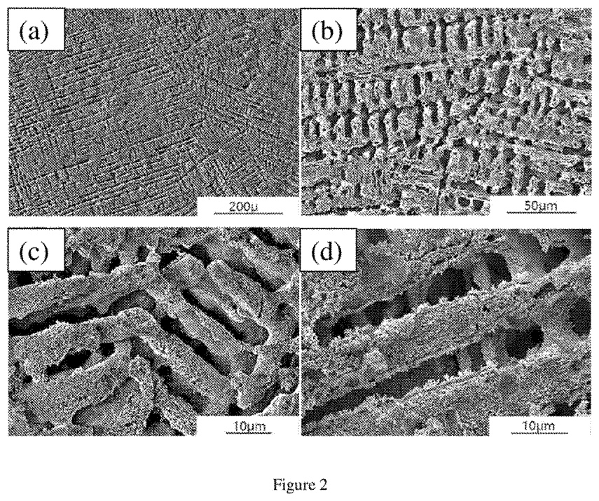

Under the given dealloying conditions, a distinctive Cu structure having a lattice-like network of dendritic micron-size channels was formed. The walls of the channels are porous with porosity in the nanometer-size range. SEM micrographs of the as-dealloyed arc-melted Cu—Mn sample are shown in FIGS. 2(a)-(d). The micrographs enable appreciation of the lattice-like nature of the etched structure derived from the formation of highly ordered and interconnected network of dendrites during cooling of the alloy melt. The observed structure is due to the preferential dissolution of the Mn rich dendritic phase, leaving large micron sized channels (5-10 μm in diameter and up to 300 μm in length) with the morphology of the pre-existing dendritic phase.

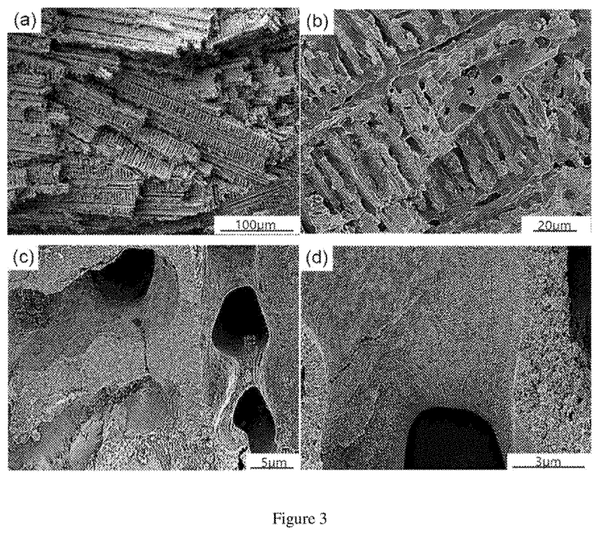

SEM micrographs of dealloyed samples taken at different length scales are shown in FIGS. 3(a)-(c). The images allow appreciating that the Cu-rich inter-dendritic phase experienced characteristic dissolution/diffusion with shorter diffusion distances during dealloying, which is responsible for the formation of meso-porous and micro-porous (<25 nm average) ligaments separating the dendritic channels. This is similarly analogous to that of the pre-existing inter-dendritic phase. The porous structure of the channel walls can be appreciated in FIG. 3(d) and FIG. 4(a)-(b).

In the case of the Au—Co alloy samples, the combined selective dissolution of (i) Co-rich dendrites, (ii) inter-dendritic Co-rich eutectic phase, and (iii) surface dealloying of Au-rich face-centered cubic (FCC) inter-dendrite phase yielded an Au structure with tri-modal distribution of porosity size. The tri-modal porosity size distribution derives from (i) micron-sized channels of up to 5 μm in average diameter and 50 μm in average length, separated by (ii) Au walls with pores in the 100-300 nm average size range, and (iii) surface characteristic nano-ligaments with average pore size of less than 50 nm.

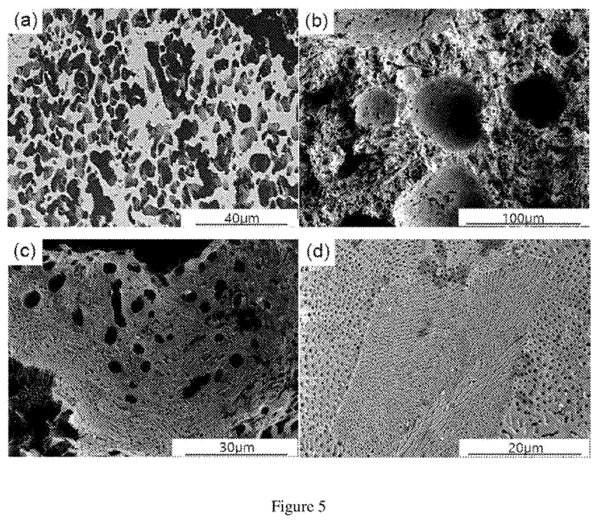

The structure of the Au structures is shown in FIGS. 5(a)-(d). FIG. 5(a) shows an SEM micrograph of the as-cooled dendritic Au₃₀Co₇₀ precursor alloy microstructure. FIGS. 5 (b)-(d) relate to cross-section SEM micrographs of the as-dealloyed Au structure.

### Example 2—Wettability Characterisation

Contact angle measurements were conducted on dealloyed Cu structures obtained in accordance with the procedure described in Example 1. Measurements were conducted on a KSV CAM 200 Tensiometer under standard conditions.

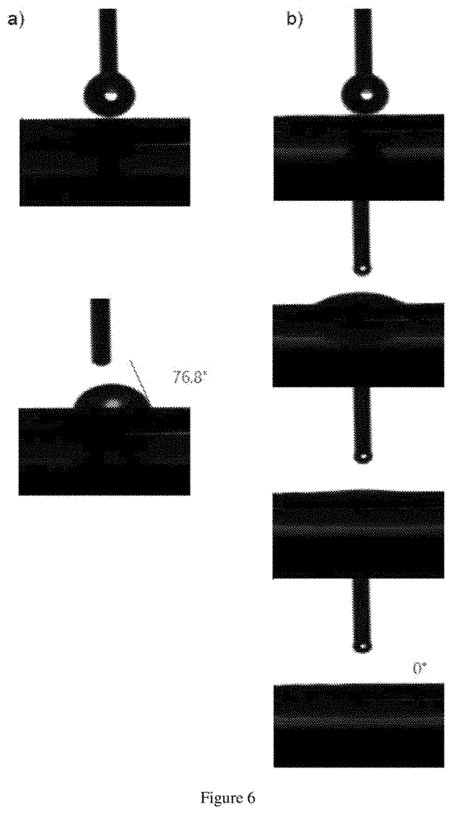

Contact angle measurements confirmed that the tested copper samples are super-hydrophilic, with contact angle of 0° (as shown in FIG. 6(b)) relative to a contact angle of 76.8° measured on dense Cu samples (as shown in FIG. 6(a)). With regard to the porous Cu structures it is evident from the test that water droplets rapidly wick into the sample structure and evenly disperse in all directions due to large capillary forces due to the multi-modal porosity of the sample structure.

Super-hydrophilicity can be particularly useful for maximum wicking and surface wetting in applications such as heat transfer (i.e. for surface rewetting yielding maximum heat transfer coefficient and heat flux removal), and for wicking of water (i.e. for evaporation humidification in antibacterial apparatuses). In that context, the super-hydrophilic nature of the porous Cu structures of the invention aids maximum wetting, utilizing the superior specific surface area of the structure in applications that depend on interactions of the Cu structure with a liquid and gas working environment.

### Example 3—Antibacterial Tests

The antibacterial properties of dealloyed Cu structures, obtained in accordance with the procedure described in Example 1, were examined. Specifically, the antimicrobial activity towards a representative bacterium, Staphylococcus Aureus, was examined. Stainless steel and dense Cu were used as negative and positive controls, respectively.

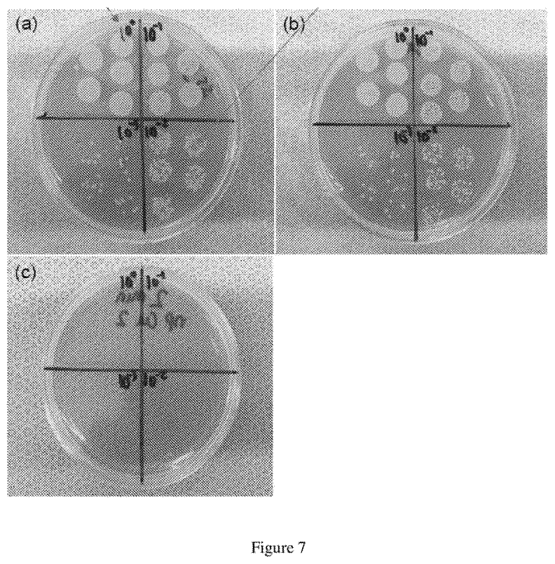

Serial dilution, agar plating and colony counting was performed in order to accurately quantify the remaining viable bacteria after exposure to metal substrates of the invention and the reference controls. FIG. 7(a)-(c) show serial dilution and plating of Staphylococcus Aureus bacteria on Tryptic Soy Agar (TSA) plates after 2 minutes of incubation with exposure to (a) stainless steel (b) dense copper and (c) porous copper disks obtained in accordance with the invention. For each petri dish shown in FIGS. 7(a)-(c), each quadrant represents a dilution factor, ranging from 1 to 10⁻³. Group of colonies (5×10 uL droplet of bacterial solution within each quadrant) grow based on number of live bacteria remaining after exposure to each substrate. Indicatively, lower density of colonies per 10 uL of solution is associated with greater antibacterial efficacy. When the number of isolated colonies lies between 30 and 300, it is acceptable for manual counting.

The porous copper structure obtained in accordance with the present invention exhibits markedly superior antibacterial properties relative to dense copper surfaces, indicating that even after exposure for only 2 minutes the porous copper of the invention shows minimal to no live bacteria remaining from a stock TSB bacterial solution containing ˜10⁸ cfu/mL (colony forming units), killing all bacteria within a very short time period. In contrast, the dense copper sample exhibited little killing efficacy within 2 minutes, similar to that observed for the stainless steel sample. The experiments were repeated nine times for each sample accounting for sample and bacterial statistical variance, and show a consistent and high-degree repeatability.

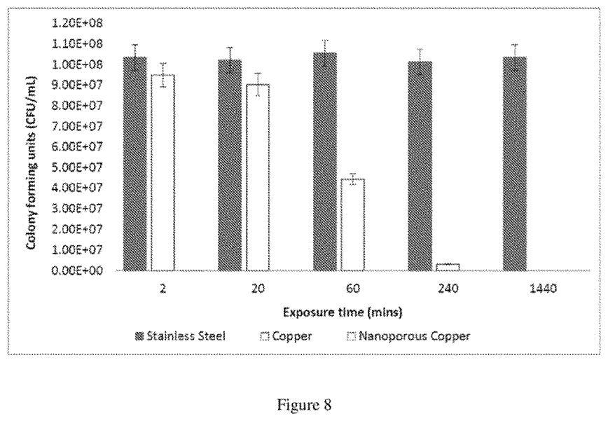

Additional experiments were also performed using the same samples and prolonged exposure to the bacteria, specifically 20, 60 240, and 1440 minutes. As shown in FIG. 8, those tests show no live bacteria after exposure to the porous Cu structure obtained in accordance with the present invention (no data bar visible for those samples), while exhibiting a slow decline of live bacteria in the case of dense Cu, still showing evidence of live bacteria after 4 hours.

Bacteria DNA staining and confocal microscopy imaging of stained bacteria deposited on stainless steel, dense Cu and porous Cu obtained in accordance to the present invention were also performed. The resulting confocal microscopy images (not shown) further confirmed presence of live bacteria after 20 minutes only on the steel and dense copper samples. No emission was detected in the case of the porous copper structures.

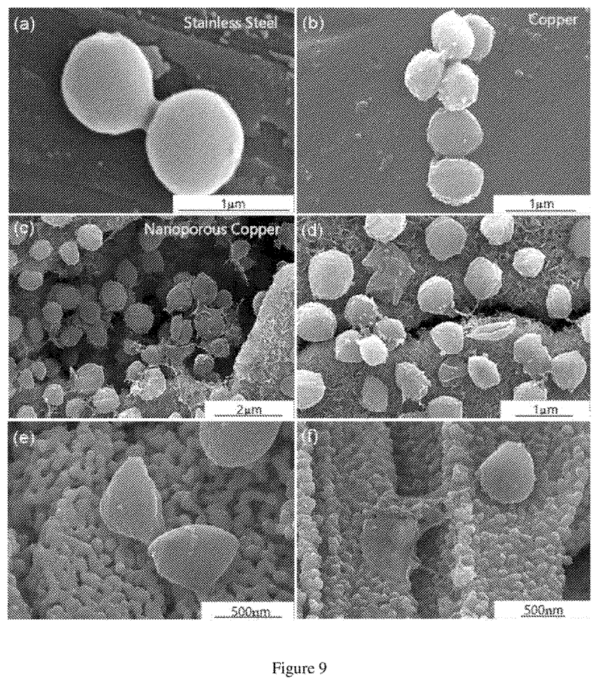

The comparatively fast degradation of test bacteria when in contact with porous Cu obtained in accordance to the present invention can also be monitored with SEM microscopy. SEM micrographs of FIGS. 9(a)-(f) show test bacteria after 2 minutes deposition on a stainless steel sample (FIG. 9(a)), a dense copper sample (FIG. 9(b)) and porous Cu obtained in accordance to the present invention (FIGS. 9(c)-(f)). The images allow appreciating the extreme cell membrane damage suffered by bacteria deposited on the porous Cu sample, as opposed to undamaged bacteria cells on stainless steel and dense copper surfaces.

Given the intrinsic nanometer-size features of the as-dealloyed copper (<25 nm) relative to the average dimension of the Staphylococcus Aureus bacteria (0.5-1 μm), the protruding nano-features can interact with the cell membrane in a unique way compared to conventional antibacterial metal foams, permitting for cell adhesion around the nano-ligaments for enhanced metal ion/cell interfacial area.

It is also believed that the exceptional death rate observed for these bacteria on the metal structures of the invention substrates may additional be due to the nano-protrusions of the samples inducing strain within the cell membrane itself. In short, it is believed that the excellent antimicrobial properties of the metal structures of the invention may derive from the combination of their high surface area and the mechanical strain induced by superficial nano-features of the structures.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method for producing a metal structure comprising a porous inter-dendritic matrix defining a network of dendritic channels, the method comprising the steps of:
preparing an alloy melt comprising a metal element and at least one alloying element,
cooling the alloy melt to a solid alloy, wherein the cooling promotes formation of a network of dendrites rich in the at least one alloying element within an inter-dendritic matrix rich in the metal,
dealloying the solid alloy to remove alloying element from (i) the dendrites and (ii) the inter-dendritic matrix to obtain the metal structure.

2. The method of claim 1, wherein the cooling is performed at a cooling rate of less than 1,000° C./s.

3. The method of claim 1, wherein the cooling is performed by casting the alloy melt.

4. The method of claim 1, wherein the alloy melt is prepared by resistance melting, arc-melting, or induction melting.

5. The method of claim 1, wherein the dealloying is performed by chemical or electrochemical etching.

6. The method of claim 1, wherein the dealloying is performed by immersing the solid alloy in an aqueous solution of an acid selected from hydrochloric acid, nitric acid, sulfuric acid, hydrobromic acid, hydroiodic acid, perchloric acid, chloric acid, and a combination thereof.

7. The method of claim 1, wherein the dealloying is performed at a dealloying temperature of between about 20° C. to about 300° C.

8. The method of claim 1, wherein the metal element is selected from copper, gold, silver, aluminium, platinum, palladium, nickel, lead, and a combination thereof.

9. The method of claim 1, wherein the at least one alloying element is selected from manganese, zinc, cobalt, iron, nickel, aluminium, indium, and a combination thereof.

10. The method of claim 1, wherein the alloy melt has an atomic content of the metal element of between about 20% and about 60%.

11. The method of claim 1, wherein the cooling promotes formation of a network of dendrites having an atomic content of the at least one alloying element of between about 60% and about 100%.

12. The method of claim 1, wherein the cooling promotes formation of an inter-dendritic matrix having an atomic content of the metal element of between about 50% and about 60%.

13. The method of claim 1, wherein the alloy melt is obtained by combining copper and manganese, gold and cobalt, gold and iron, gold and nickel, aluminium and zinc, copper and zinc, silver and aluminium, platinum and iron, platinum and aluminium, palladium and manganese, palladium and cobalt, or nickel and manganese.

14. A metal structure obtained by the method of claim 1.

15. A metal structure comprising a porous inter-dendritic matrix defining a network of dendritic channels.

16. The metal structure of claim 15, wherein the inter-dendritic matrix is meso-porous, and the dendritic channels have an average cross-sectional size of between about 1 and about 100 μm.

17. The metal structure of claim 15, wherein the inter-dendritic matrix comprises pores having an average size of between about 20 and about 1,000 nm.

18. The metal structure of claim 15, which is made of a metal selected from copper, gold, silver, aluminium, platinum, palladium, nickel, and a combination thereof.

19. The metal structure of claim 15, wherein the porous inter-dendritic matrix has a Vickers Hardness (HV 300 gf/10 s) of between about 50 and about 200.

20. The metal structure of claim 15, structure being hydrophilic and providing for a static contact angle with water of less than 45°.

21. The metal structure of claim 15, the structure being super-hydrophilic and providing for a static contact angle with water of about 0°.

22. An antimicrobial device comprising a metal structure according to claim 15.

23. The device of claim 22, being selected from a filter, a touch surface, and a container for liquids.

24. The device of claim 22, wherein the metal structure is made of copper.
